(19) United States
(12) Patent Application Publication
(10) Pub. No.: US 2001/0015282 A1
(43) Pub. Date: Aug. 23, 2001

(54) Electrical cable and method for installing and stripping an electrical cable

(76) Inventor: Mark Scantlebury, Hamilton (NZ)

Correspondence Address: DANN DORFMAN HERRELL & SKILLMAN, SUITE 720, 1601 MARKET STREET, PHILADELPHIA, PA, 19103-2307, US

(21) Appl. No.: 09/734,372

(22) Filed: Dec. 11, 2000

(30) Foreign Application Priority Data
Dec. 9, 1999 (NZ) 501686
Aug. 18, 2000 (NZ) 506385

(51) Int. Cl. H01B 7/08

(52) U.S. Cl. 174/117 F

(57) ABSTRACT

A cable comprising at least one conductor and an outer sheath surrounding the conductor(s) includes an integrally molded tab extending from one side of the outer sheath and of a height and thickness enabling a fastener to extend through the tab to secure the cable to a surface or support. The tab may be of a thickness enabling the tab to be nailed, stapled, or screwed through without pre-forming a hole or holes in the tab or alternatively the tab may include pre-formed holes at regular spacings.

### FIELD OF INVENTION

The invention comprises an electrical cable and method of installing an electrical cable, and a method of stripping an electrical cable.

### BACKGROUND

Electrical cables typically comprise one or more conductors and an outer sheath surrounding the conductors. Commonly the conductors are metallic wires which are individually insulated, and contained in and surrounded by the outer sheath. The conductor or conductors need not necessarily be metallic however and in for example telecommunications and computer or information technology applications the conductor or conductors will commonly be an optical fibre or fibres. The term “conductor” in this specification is to be understood as not limited to solely metallic conductors.

Cabling commonly used in domestic and typical commercial applications for single phase wiring for example, typically comprises phase, neutral and earth wires which are individually insulated and in turn are contained within a plastic outer sheath which keeps the conductors together and further protects the conductors. Such cabling is commonly referred to as “twin and earth” cable.

To install such cabling in use during the construction of a house or the wiring of a commercial building commonly clips are used to hold the cable in place. Alternatively it is common to drill through structural members of a wall and pass the cable through the drilled holes, or to install a plastic conduit in which the cable is in turn installed to retain the cable in position. Cable trays may also be first installed which carry a number of cables.

### SUMMARY OF INVENTION

The invention provides an improved or at least alternative form of electrical cable and method for installing same.

In broad terms in one aspect the invention comprises an electrical cable comprising at least one conductor and an outer sheath surrounding the conductor(s) which includes an integrally moulded tab extending from one side of the outer sheath and of a height and thickness enabling a fastener to extend through the tab to secure the cable to a surface or support.

Preferably the tab is a continuous web on one side of the outer sheath, and is of a thickness enabling the tab to be nailed, stapled, or screwed through without pre-forming a hole or holes in the tab.

Typically the cable comprises two or more conductors surrounded by the outer sheath and the tab extends to one side of the outer sheath containing the two or more conductors. Typically the conductors are arranged in a common plane across the longitudinal axes of the conductors and the tab extends to one side of the outer sheath and in a plane substantially parallel to or in line with the plane through the conductors.

In one form of the cable of the invention a junction between the tab or flange and the outer sheath is mechanically weaker than the tab or outer sheath itself whereby the tab to be manually torn from the outer sheath to open the outer sheath. Manually tearing the tab away from the outer sheath opens the outer sheath and enables an end portion of the outer sheath to be removed conveniently, before the conductors within are stripped and terminated for example.

In an alternative form of electrical cable of the invention the tab is a single discrete tab which is not continuous along the length of the cable and the cable comprises a number of said single discrete tabs regularly spaced along the length of the cable. Such tabs may comprise preformed holes through the tabs through which a fastener may pass to secure the cable to a surface or support, or may also be intended to be nailed, stapled, or screwed through to fix the cable in position when installing the cable.

In broad terms in another aspect the invention comprises a method of securing an electrical cable to a surface or support(s) comprising driving a number of fasteners through a tab integrally moulded with the outer sheath of the cable and extending from one side of the outer sheath, at spaced locations along the length of the cable and into the surface or support(s).

In broad terms in a further aspect the invention comprises a method of stripping the outer sheath from an electrical cable comprising manually tearing a continuous tab integrally moulded with the outer sheath of the cable along one side of the cable, along a junction between the tab and the outer sheath which is weaker than the material of the tab or outer sheath itself to thereby remove the tab and open the outer sheath of the cable.

### BRIEF DESCRIPTION OF THE DRAWINGS

The invention will be further described with reference to the accompanying drawings which show preferred forms of the cable of the invention, by way of example and without intending to be limiting. In the drawings:

FIG. 1 is a perspective view of a length of a preferred form cable of the invention with an integrally moulded tab,

FIG. 2 is an end on view of a length of the preferred form cable of FIG. 1 fixed to a supporting surface,

FIG. 3 is a view of a length of cable similar to that of FIGS. 1 and 2 but with a series of preformed holes in the integral tab,

FIG. 4 is a view of another form of cable of the invention comprising a series of discrete tabs regularly spaced along the length of the cable, and

FIG. 5 is a view of a further preferred form cable of the invention, constructed such that the moulded tab of the cable may be torn away to open the end of the cable sheath.

### DETAILED DESCRIPTION OF PREFERRED FORMS

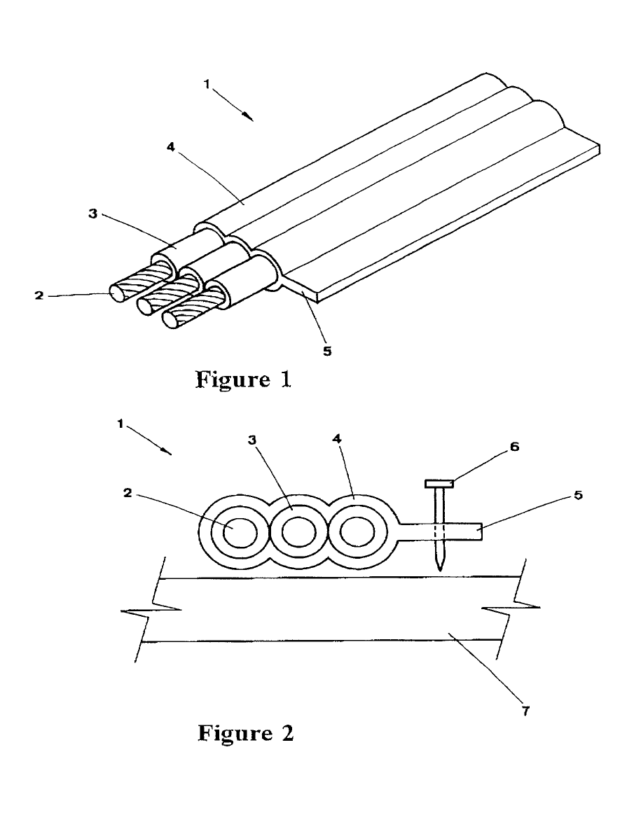

The preferred form cable shown in FIGS. 1 and 2 comprises three conductors 2 which are individually insulated for example by a layer of plastic insulation 3, and are in turn encased within an outer sheath 4. Typically the outer sheath 4 is also formed from a plastics material by extrusion.

The cable includes a tab 5 which in the form of cable of these figures is a continuous tab along the length of the cable, and which is integrally moulded with the outer sheath 4. In the preferred form the tab 5 is extruded with the outer sheath from the same plastics material.

The height of the tab 5 is such that a fastener such as a nail 6 (see FIG. 2) can extend through the tab to secure the cable to a surface or support. The thickness of the plastic web forming the tab 5 is such that the lab may be easily nailed, stapled, or screwed through without pre-forming a hole or holes in the tab, with the nails, staples or screws piercing the tab 5.

To fix the cable in position to a surface or other support such as wooden structural members of a house or building or similar the installer may simply nail, staple or screw through the tab into the surface or support below, at whatever location(s) along the length of the cable at which the installer wishes to provide a fixing point or points for the cable. The nails, staples or screws will pierce through the plastics material of the tab 5 as the nails are hammered home, staples are installed with a staple gun, or screws are screwed through the tab 5. Alternatively however holes may be preformed along the length of the tab 5 during manufacture of the cable.

The cable may be of a type commonly used for domestic or commercial wiring, or heavier industrial cable incorporating a continuous tab which is integral with the outer sheath of the cable where the cable is a multi-conductor cable preferably the tab extends from one side of the outer sheath, and in a plane substantially parallel to or in line with a plane through the conductors as shown. This gives the cable a flat shape as shown in the drawings, so that the cable, will sit against a surface or support to which the cable is secured by fasteners through the extending tab 5. Other arrangements are possible however and for example three conductors could be arranged in a triangular configuration with the tab extending from along a corner of the sheath.

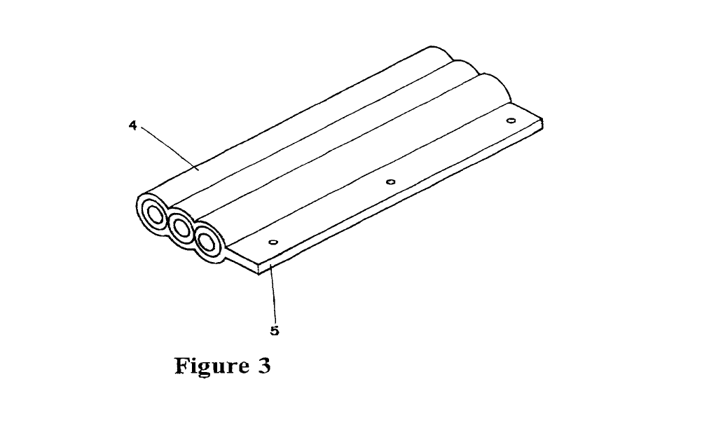

FIG. 3 shows a form of cable which is similar to that of FIGS. 1 and 2 except that holes 6 are preformed at regular intervals along the length of the tab 5 as shown.

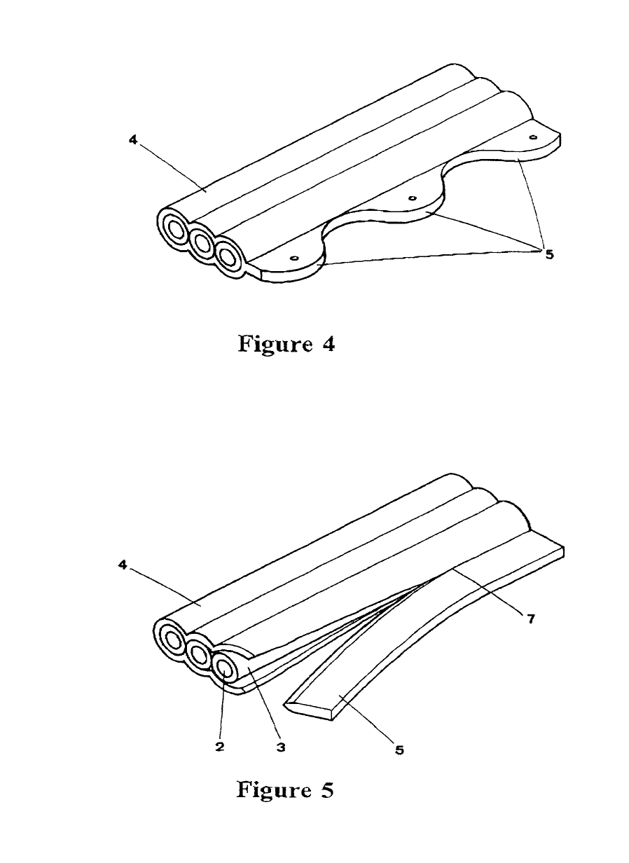

In the cable shown in FIGS. 1, 2 and 3 the integral tab is formed as a continuous flange on one side of the outer sheath, but FIG. 4 shows an alternative form of cable of the invention in which the tab is a single discrete tab which is not continuous along the length of the cable, and wherein a number of such single discrete tabs 5 are regularly spaced along the length of the cable as shown. Holes may be preformed through these tabs or alternatively they may also be intended to he nailed, stapled or screwed through as described above. These tabs may be of any desired shape.

FIG. 5 shows another form of cable of the invention, in which the junction 7 between the tab 5 and the outer sheath 4 is formed so as to be mechanically weaker than the tab or outer sheath itself. This enables the outer sheath 4 to be stripped from the cable at an end of the cable where the conductors are to be exposed for termination, by the installer grasping the end of the cable in one hand and the tab 5 in the other and tearing the tab 5 away from the outer sheath. This will open the outer sheath and expose the conductors within the outer sheath as shown in FIG. 4. The end material of the tab and outer sheath may then he conveniently cut away with pliers for example, to expose the individual conductors for stripping and termination.

Optionally in forms of cable of the invention in which the conductor(s) is/are optical fibre(s) the outer sheath may be constructed of a material with a known refractive index or may have a gradiated refractive index in order to minimise the light loss along the length of the cable.

Optionally the integral tab or flange may contain information or indicators, such as the name of the manufacturer or distributor, or markings to indicate to the installer the length of cable used. The flange may also optionally be colour coded to show information such as the capacity of the cable or the cable type. Also the flange may contain a free form area that the installer can use to hold information deemed useful or necessary during installation.

The foregoing describes the invention including preferred forms thereof. Alterations and modifications as will be obvious to those skilled in the art are intended to be incorporated within the scope hereof, as defined in the accompanying claims.

1. An electrical cable comprising at least one conductor and an outer sheath surrounding the conductor(s) which includes an integrally moulded tab extending from one side of the outer sheath and of a height and thickness enabling a fastener to extend through the tab to secure the cable to a surface or support.

2. An electrical cable according to claim 1 wherein the tab is of a thickness enabling the tab to be nailed, stapled, or screwed through without pre-forming a hole or holes in the tab.

3. An electrical cable according to claim 1 wherein the tab is a continuous web on one side of the outer sheath.

4. An electrical cable according to any one of claims 1 to 3 wherein the cable comprises two or more conductors surrounded by the outer sheath and the tab extends to one side of the outer sheath containing the two or more conductors.

5. An electrical cable according to claim 4 wherein said two or more conductors are arranged in a common plane across the longitudinal axes of the conductors and the tab extends to one side of the outer sheath and in a plane substantially parallel to or in line with the plane through the conductors.

6. An electrical cable according to claim 4 wherein said two or more conductors are arranged in a common plane across the longitudinal axes of the conductors and the tab extends to one side of the outer sheath in the plane through the conductors.

7. An electrical cable according to any one of the preceding claims wherein a junction between the tab or web and the outer sheath is mechanically weaker than the tab or outer sheath itself whereby the tab to be manually torn from the outer sheath to open the outer sheath.

8. An electrical cable according to any one of the preceding claims wherein the outer sheath and integral tab are formed by extrusion from a plastics material.

9. An electrical cable according to claim 1 wherein the tab is a single discrete tab which is not continuous along the length of the cable and wherein the cable comprises a number of said single discrete tabs regularly spaced along the length of the cable.

10. An electrical cable according to claim 9 wherein said tabs comprise preformed holes through the tabs through which a fastener may pass to secure the cable to a surface or support.

11. A method of securing an electrical cable to a surface or support(s) comprising driving a number of fasteners through a tab integrally moulded with the outer sheath of the cable and extending from one side of the outer sheath, at spaced locations along the length of the cable and into the surface or support(s).

12. A method according to claim 11 wherein the tab is a continuous flange on one side of the outer sheath.

13. A method according to claim 12 wherein the cable comprises two or more conductors surrounded by the outer sheath and the tab extends to one side of the outer sheath containing the two or more conductors.

14. A method according to claim 13 wherein said two or more conductors are arranged in a common plane across the longitudinal axes of the conductors and the tab extends to one side of the outer sheath and in a plane substantially parallel to or in line with the plane through the conductors.

15. A method according to any one of claims 11 to 14 wherein said fasteners are nails, staples or screws.

16. A method according to any one of claims 11 to 15 wherein said tab does not have preformed holes through the tab, and including causing the fasteners to pierce through the tab.

17. A method of stripping the outer sheath from an electrical cable comprising manually tearing a continuous tab integrally moulded with the outer sheath of the cable along one side of the cable, along a junction between the tab and the outer sheath which is weaker than the material of the tab or outer sheath itself to thereby remove the tab and open the outer sheath of the cable.

18. An electrical cable substantially as illustrated in FIGS. 1 and 2 of the accompanying drawings and described with reference thereto.
